(19) United States
(12) Patent Application Publication
(10) Pub. No.: US 2002/0191568 A1
(43) Pub. Date: Dec. 19, 2002

(54) Adaptive chip equalizers for synchronous DS-CDMA systems with pilot sequences

(75) Inventor: Monisha Ghosh, Chappaqua, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/978,118

(22) Filed: Oct. 15, 2001

Related U.S. Application Data
(60) Provisional application No. 60/279,821, filed on Mar. 29, 2001.

(51) Int. Cl. H04B 7/216

(52) U.S. Cl. 370/335; 370/503

(57) ABSTRACT

A system and method for communicating over a single communication channel in a Direct Sequence-Code Division Multiplex (DS-CDMA) communication system. A pilot signal normally used for synchronization and channel estimation is now used as a training sequence for a chip-equalizer implemented in a mobile handset receiver device. The pilot sequence is always present in the data stream and may be continually used for equalizer adaptation at the mobile handset receiver. The method of using a pilot sequence(s) in order to adapt the taps of a chip equalizer occurs prior to despreading the user data. Additionally, a plurality of pilot sequences each having a known chipping sequence are generated and transmitted for continuous equalizer adaptation at the mobile handset receiver. The plurality of pilots received enables greater adaptation speed, thus enabling efficient tracking of fast varying channels. The method implements a least squares algorithm for enabling fast adaptation in rapidly fading channels using multiple pilot sequences.

### CROSS-REFERENCE TO RELATED APPLICATIONS

The following patent application claims the benefit of U.S. Provisional Patent Application Serial No. 60/279,821 filed Mar. 29, 2001.

### BACKGROUND OF THE INVENTION

1. Field of the Invention

The present invention relates to wireless communication systems and particularly, to a system and method for performing adaptive chip-equalization for DS-CDMA systems with pilot sequences.

2. Discussion of the Prior Art

Multiuser detection for cellular CDMA systems has been a very active research area for a number of years. A large part of the research has been devoted to solving the uplink problem where the multiple users are not orthogonal to each other. Methods developed for the uplink can be fairly computation intensive as the base station receivers are not particularly cost sensitive. In addition, since the base station has to demodulate all users anyway, techniques like parallel and successive interference cancellation can be used.

At the handset, however, the rake receiver is still the receiver that is most commonly implemented primarily for cost reasons since the handset has limited computational complexity. Thus, techniques like interference cancellation have to be ruled out. In the following references: A. Klein, “Data detection algorithms specially designed for the down-link of CDMA mobile radio systems,” IEEE 47^{th} VTC Proceedings, vol. 1, pp. 203-207, May 1997, and K. Hooli, M. Latva-aho, and M. Juntti, “Multiple access interference suppression with linear chip equalizers in WCDMA downlink receivers”, IEEE GLOBECOME '99, vol. 1, pp. 467-471, December 1999, there is demonstrated the capacity gain that can be obtained by using a chip-equalizer prior to despreading in a downlink receiver. The question of adaptation algorithms is not addressed. In the reference G. Caire and U. Mitra, “Pilot-aided adaptive MMSE receivers for DS/CDMA,” IIC '99I, vol. 1, pp. 57-62, June 1999, an adaptive method of interference cancellation using pilot sequences is described which estimates the channel response instead of the inverse channel response. The receiver structure being considered is not a chip-based equalizer but a traditional multi-user detector using channel matrices. In M. K. Tasatsanis, “Inverse filtering criteria for CDMA systems”, IEEE Trans. Signal Proc., vol. 45, no. 1, pp. 102-12, January 1997, inverse filtering is studied for CDMA; however, the emphasis is on blind methods which are usually too slow for fast fading channels. Chip-equalizers are also studied in the references to P. Komulainen, M. J. Heikkilä and J. Lilleberg, “Adaptive channel equalization and interference suppression for CDMA downlink”, IEEE 6^{th} Int. Symp. On Spread-Spectrum Tech. & Appln., vol. 2, pp. 363-367, September 2000; T. P. Krauss, W. J. Hillery and M. D. Zoltowski, “MMSE equalization for forward link in 3G CDMA: symbol-level versus chip-level”, IEEE Workshop on Stat. Signal and Array Proc., vol. 1, pp. 18-22, August 2000; and, M. J. Heikkilä, P. Komulainen, and J. Lilleberg, “Interference suppression in CDMA downlink through adaptive channel equalization”, IEEE VTC Proceedings, vol. 2, pp. 978-982, Sept. 1999. September 2000. In the reference to M. J. Heikkilä, P. Komulainen, and J. Lilleberg entitled “Interference suppression in CDMA downlink through adaptive channel equalization”, assuming the channel values can be estimated by a pilot sequence, the Griffith's algorithm is used to adaptively estimate the equalizer taps.

In most systems using adaptive equalizers, training sequences are sent periodically to adapt the equalizer taps. In a mobile cellular environment however, this can be impractical since the channel changes are very rapid and the overhead too large if every user has to have its own training sequence. For instance, in a single downlink channel for a CDMA system implementing Walsh-Hadamard spreading sequence, orthogonal channelization is provided for up to 64 users on a single channel. For each user, a training sequence is transmitted periodically for adapting the equalizer chip at each user's mobile handset receiver to enable reception of the proper data sequence for that user. This greatly contributes to the overhead of the system as the amount of information throughput on the downlink channel becomes limited.

It would thus be highly desirable to provide a system and method for enabling adaptive chip equalization for multiple users on the downlink channel in a synchronous DS-CDMA system in a manner that obviates the need for transmitted training sequences for each user.

Moreover, it would thus be highly desirable to provide a system and method utilizing a single training sequence that is always present in the data stream and can continually be used for equalizer adaptation in synchronous DS-CDMA systems.

### SUMMARY OF THE INVENTION

Accordingly, it is an object of the present invention to provide a service that facilitates adaptive chip equalization for multiple users on the downlink channel in a synchronous DS_CDMA system in a manner that obviates the need for transmitted training sequences for each user.

It is a further object of the present invention to provide a system and method utilizing a single training sequence that is always present in the data stream and can continually be used by multiple users for equalizer adaptation in synchronous DS-CDMA systems.

In the preferred embodiment of the invention, the single training sequence comprises a transmitted pilot sequence which is primarily used by a mobile receiver for synchronization and channel estimation in most synchronous DS-CDMA systems, like IS-95 and UMTS downlinks. Thus, according to a first aspect of the invention, for a chip-equalizer, one or more pilot sequences is used as a training sequence that is always present in the data stream and that may be continually used for equalizer adaptation at the mobile handset receiver. Preferably, the method of using these pilot sequence(s) in order to adapt the taps of a chip equalizer occurs prior to despreading the user data. The use of pilot sequence(s) for adapting the taps of a chip equalizer wherein the adaptation is performed at the symbol rate.

According to another aspect of the invention, a plurality of pilot sequences each having a known chipping sequence is generated and transmitted for continuous equalizer adaptation at the mobile handset receiver. The plurality of pilots received enables greater adaptation speed, thus enabling efficient tracking of fast varying channels. Additionally the invention comprises a least squares algorithm enabling fast adaptation in rapidly fading channels that uses multiple pilot sequences.

Advantageously, the receiver does not need any information about other users' sequences and powers; the pilot sequence(s) and power level transmitted on the downlink channel of the synchronous DS-CDMA system is assumed to be known to all users.

### BRIEF DESCRIPTION OF THE DRAWINGS

Details of the invention disclosed herein shall be described below, with the aid of the figures listed below, in which:

FIG. 1 illustrates a transmitter and receiver model 10 for each of the “N” users in the DS-CDMA downlink channel according to the principles of the present invention;

FIG. 2 illustrates a numerical evaluation of e_{λ}′ and eₖ and particularly, the theoretical comparison of performance with a rake receiver and with a chip equalizer for an example transmission system;

FIG. 3 illustrates the same evaluation for a system as described with respect to FIG. 2, however, where the pilot power is 20% of the total transmitted power;

FIG. 4 illustrates the same evaluation for a system as described with respect to FIG. 2, however, instead of all of the users at the same power, two users are chosen with a 20 dB transmit power difference; and,

FIG. 5 illustrates the performance of a least squares estimator on a 5-tap (chip spaced) Rayleigh fading channel with mobile speed of 60 mph.

### DETAILED DESCRIPTION OF THE PREFERRED EMBODIMENTS

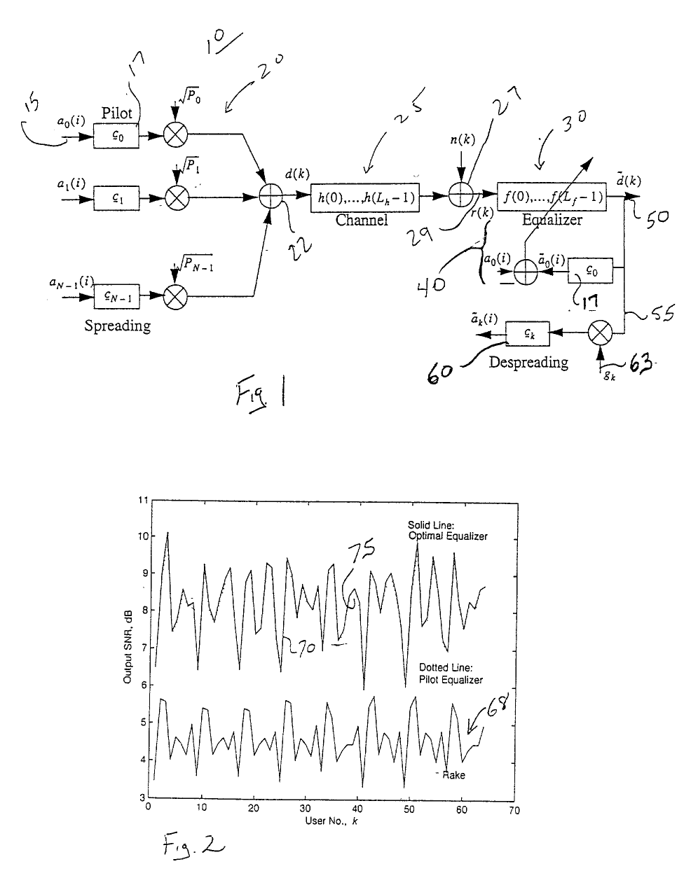

FIG. 1 illustrates a transmitter and receiver model 10 for each of the “N” users in the DS-CDMA downlink channel according to the principles of the present invention. As shown, data aₖ(i) representing the symbol stream for each user k, is to be transmitted from the transceiver at the base station 20, for example, over downlink channel 25 for receipt by the a receiver structure 30 at the mobile handset. This structure 20 according to the invention described and illustrated with respect to FIG. 1 is similar to those considered in the above-identified references to K. Hooli, M. Latva-aho, and M. Juntti entitled “Multiple access interference suppression with linear chip equalizers in WCDMA downlink receivers”, and to P. Komulainen, M. J. Heikkilä and J. Lilleberg entitled “Adaptive channel equalization and interference suppression for CDMA downlink”, etc. All quantities are assumed to be real, with the extension to complex terms being straightforward.

For purposes of discussion, the transmission system for model 10 is assumed to be synchronous DS-CDMA. The spreading sequences are assumed to be orthogonal and white. This requirement may be met, for example, by using the Walsh-Hadamard sequence set of size ‘N’ and scrambling each sequence by the same PN sequence of length ‘N’. Though the results here are developed for short PN sequence scrambling, simulation results with long PN sequence scrambling show the same performance. Let T_{c} be the chip interval and T the symbol interval. Then T_{c}=NT where N is the length of the spreading sequence and hence the maximum number of users that can be supported by the system.

With respect to FIG. 1, and as will be described herein with respect to the following, a subscript denotes the user index and a bracketed variable denotes time index. Hence, the waveform of user k, denoted as Sₖ(t) may be written as:

$${s}_{k} ( t ) = \sqrt{{P}_{k}} {\sum }_{i = 0}^{{N}_{s} - 1} {a}_{k} ( i ) {c}_{k} ( t - iT ) \qquad ( 1 )$$

where Nₛ is the number of transmitted symbols, aₖ(i) is the symbol stream for user k, Pₖ is the power of user k, and cₖ(t) is the spreading signal for user k given by:

$${c}_{k} ( t ) = {\sum }_{n = 0}^{N - 1} {c}_{k} ( n ) Π ( t - {nT}_{c} ) \qquad ( 2 )$$

where Π(t) is a rectangular pulse in (0,T_{c}) and [cₖ(0) cₖ (1) . . . cₖ(N−1)] is the spreading sequence of user k. According to the invention, as will be described in greater detail herein, it is assumed that one user a₀(i), comprises a pilot symbols 15, with the associated spreading sequence 17 denoted as c₀(t). With the above description of an individual user, the composite transmitted signal d(t) 22 due to all N users may be written as:

$$d ( t ) = {\sum }_{k = 0}^{N - 1} {s}_{k} ( t ) = {\sum }_{k = 0}^{N - 1} \sqrt{{P}_{k}} {\sum }_{i = 0}^{Ns - 1} {a}_{k} ( i ) {\sum }_{n = 0}^{N - 1} {c}_{k} ( n ) Π ( t - iT - {nT}_{c} ) \qquad ( 3 )$$

As shown in FIG. 1, the transmitted signal due to all users goes through the same multipath channel 25, represented as h(t), and is received with added noise 27 at the receiver 30. The baseband received signal 29, i.e., r(k), after front-end synchronization and sampling at the chip-rate T_{c} may then be expressed as:

$$r ( k ) = {\sum }_{i = 0}^{{L}_{h} - 1} h ( i ) d ( k - i ) + n ( k ) \qquad ( 4 )$$

where Lₕ is the length of the multipath channel, n(k) is complex additive white gaussian noise (AWGN) of mean zero and variance σₙ² and the sampled transmitted sequence d(1) is:

$$d ( l ) = d ( {lT}_{c} ) = {\sum }_{k = 0}^{N - 1} \sqrt{{P}_{K}} {\sum }_{i = 0}^{{N}_{s} - 1} {a}_{k} ( i ) {\sum }_{n = 0}^{N - 1} {c}_{k} ( n ) Π ( ( l - n - iN ) {T}_{c} ) \qquad ( 5 )$$

### THE MINIMUM-MEAN-SQUARED-ERROR (MMSE) RECEIVER

As shown in FIG. 1, the received signal r(k) is first sampled at the chip rate and then processed by an adaptive linear chip-equalizer f 40 of length L_{f}. This equalizer operates on the complete received signal, which includes all users including the pilot 15, which as denoted above for illustrative purposes, is denoted as user a₀(k). At the equalizer output, the desired user's data sequence is obtained by despreading with its spreading sequence. Hence, the equalizer output, \tilde{d}(k) 50 is given by:

$$\tilde{d} ( k ) = {\sum }_{i = 0}^{{L}_{f} - 1} f ( i ) r ( k + {d}_{f} - i ) \qquad ( 6 )$$

where d_{f} is the delay through the equalizer 40. The k^{th} data sequence 55 is then despread by despreader 60 as:

$${\tilde{a}}_{k} ( m ) = {\sum }_{i = 0}^{N - 1} \tilde{d} ( mN + i ) {c}_{k} ( i ) \qquad ( 7 )$$

All scaling is assumed to be included in the equalizer taps f. The MMSE equalizer taps for the k^{th}h user is determined by minimizing the MSE E[|ãk(m)- aₖ(m)|²] for that user. It is straight forward to show that the MMSE taps fₖ for user k are given by:

ƒₖ=Hₖ⁻¹yₖ (8)

where the matrix Hₖ is given according to equation (9) as follows:

$${H}_{k} ( i , j ) = {\sum }_{p = 0}^{N - 1} {\sum }_{n = 0}^{N - 1} {c}_{k} ( p ) {c}_{k} ( n ) E [ r ( mN + p + {d}_{f} - i ) r ( mN + n + {d}_{f} - j ) ] , i , j = 0 , 1 , … {L}_{f} - 1 \qquad ( 9 )$$

and yₖ is given by:

$${\underline{y}}_{k} ( i ) = {\sum }_{p = 0}^{N - 1} {c}_{k} ( p ) E [ {a}_{k} ( m ) r ( mN + p + {d}_{f} - i ) ] , i = 0 , 1 , … {L}_{f} - 1 \qquad ( 10 )$$

The MMSE due to the above taps is given by

$${e}_{k} = 1 - {\underline{f}}_{k}^{T} {\underline{y}}_{k} .$$

In general, the solution ƒₖ is a function of k , i.e. the optimum set of taps will be different for each user, depending on its spreading sequence.

There has been much analysis on the MMSE equations for a particular user and the performance enhancement that may be obtained over a rake receiver. According to the present invention, however, while the physical channel 25, i.e., h(t), encountered by all users is the same, it is reasonable to expect that there exists one set of equalizer taps, that is optimal, or at the very least “close” to optimal, for all users. That is, according to the invention, the equalizer taps f₀ derived for the pilot sequence are “close” to the equalizer taps for any other user, up to a scale factor, as will now be described. As shown in FIG. 1, without loss of generality, it is assumed that the pilot spreading sequence is c₀(n) 17, and the MMSE taps for the pilot sequence is ƒ₀. Assuming that the equalizer taps

$${\underline{f}}_{k}^{′} = {g}_{k} {\underline{f}}_{0}$$

are used for the k^{th} user instead of the MMSE taps ƒₖ, where gₖ is a gain 63 that minimizes the Mean Squared Error (MSE) when

$${\underline{f}}_{k}^{′}$$

is used as the equalizer 40. It is easily derived that

$${g}_{k} = ( {\underline{f}}_{0}^{T} {H}_{k} {\underline{f}}_{0} ) / {\underline{f}}_{0}^{T} {\underline{y}}_{k}$$

and that the MSE due to using

$${\underline{f}}_{k}^{′}$$

instead of ƒ_{λ} is given by

$${e}_{k}^{′} = {g}_{k}^{2} {\underline{f}}_{0}^{T} {H}_{k} {\underline{f}}_{0} - 2 {g}_{k} {\underline{f}}_{0}^{T} {\underline{y}}_{k} + 1.$$

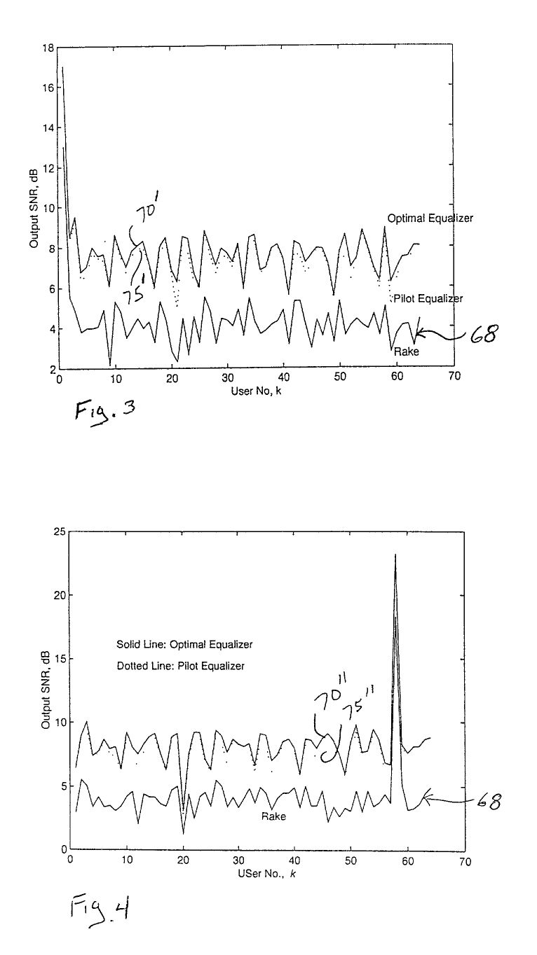

FIG. 2 illustrates a numerical evaluation of e₈₀′ and eₖ and particularly, the theoretical comparison of performance with a rake receiver and with a chip equalizer for an example transmission system. The parameters for the transmission used are: N=64, L_{f}=10, d_{f}=4 and chip SNR=−5 dB. The system is fully loaded with equal transmitted power for all users, and one pilot sequence. The binary Walsh-Hadamard sequence set with short-PN sequence scrambling is used along with BPSK data [+1,−1]. A two ray fixed channel h=[1.0 0.9] was implemented for exemplary purposes. This is a very severe channel and the rake receiver performs very poorly, delivering an average output SNR of about 4.5 dB as represented by line 68. The output SNR is the symbol SNR after equalization and despreading, i.e., 10 log(1/eₖ), when the optimal equalizer ƒₖ is used for user k, and is represented as line 70 in FIG. 2. The output SNR after equalization and dispreading is 10 log(1/eₖ′) when the equalizer

$${\underline{f}}_{k}^{′}$$

is used for user k, and is represented as dotted line 75 in FIG. 2. From FIG. 2, it is readily shown that the output SNR 70 after equalization and despreading for the prior art equalizer adapted according to a transmitted training sequence, and the output SNR 75 after equalization and despreading for the chip equalizer adapted according to the pilot sequence are almost identical, i.e., an average of about 8.0 dB across users, which is a 3.5 dB improvement in performance over the output SNR rake receiver 68.

FIG. 3 illustrates the same evaluation for a system as described with respect to FIG. 2, however, where the pilot power is 20% of the total transmitted power. Here it is seen that the difference in output SNRs 70′, 75′ corresponding to the respective output SNRs 70, 75 of FIG. 2, is a little greater than the output SNRs 70, 75 shown for the system exemplified in FIG. 2. Additionally, the average output SNR is about 0.8 dB lower than in FIG. 2. This is because when the pilot power increases, the power of all the other users decreases for the same total transmitted power.

Thus, the results described herein with respect to FIG. 3 indicate that sending the pilot at a higher power is not necessarily the best design if chip-equalizers adapted on the pilot are going to be used in the receiver. In conventional DS-CDMA systems the pilot is sent at a higher power to facilitate the evaluation of the channel estimates that are used by the rake. In the reference to P. Komulainen, M. J. Heikkilä and J. Lilleberg entitled “Adaptive channel equalization and interference suppression for CDMA downlink”, it is assumed that the channel parameters are known in the adaptation of the chip equalizer, in which case the pilot would also be sent at a higher power. However, according to the invention, when the chip equalizer is adapted directly on the pilot sequence, the channel is not estimated directly and hence the pilot power does not need to be increased relative to the other users. This means that more of the available transmit power can be used for user data.

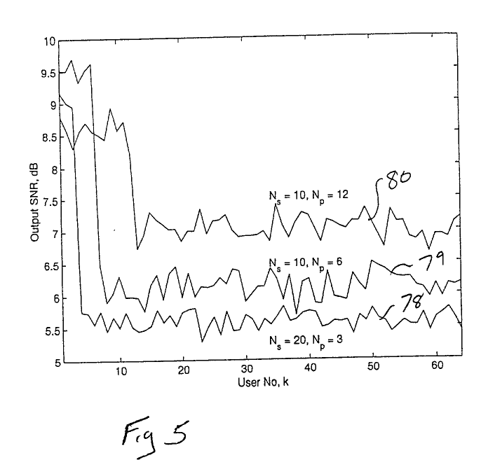

FIG. 4 illustrates the same evaluation for a system as described with respect to FIG. 2, however, instead of all of the users at the same power, two users are chosen with a 20 dB transmit power difference. For example, a first user P₂₀=0.25 and a second user at P₅₈=25. All other users, including the pilot, have Pₖ=1. The rake receiver in this case gives unacceptable results 68 for all the users with lower power, but the pilot based equalizer output SNR 75″ is again very close in performance to the optimal equalizer output SNR 70″. This result indicates that downlink power control over a wide range is possible in a system with chip-equalizers adapted on the pilot.

### LEAST SQUARES (LS) SOLUTION USING MULTIPLE PILOTS

In accordance with a second embodiment of the invention, for the kind of equalizer structure 40 in the receiver depicted in FIG. 1, instead of having one pilot at a higher power, it is more efficient in terms of tracking the downlink channel if there are multiple pilots, e.g., five pilots at one-fifth the power, or ten pilots at one-tenth the power, etc. Thus, every user would utilize the number of pilot sequences, e.g., 5 or 10, or whatever number of pilots had been chosen in the system, to adapt the equalizer. Advantageously, the equalizer adapts much faster because now at every adaptation step, there will be a number of errors associated with the number of pilot sequences, e.g., 5 or 10, that can be minimized and used to expedite equalizer adaptation speed. The result is that a mobile handset can be moving at a much higher speed and still be having good transmission than if only a single pilot was implemented.

Considering a DS-CDMA system that has equal transmitted power on all spreading sequences and Nₚ of the N spreading sequences reserved for known pilot sequences. Without loss of generality, these sequences be numbered 0 to Nₚ-1. Hence, in every received symbol interval, there are Nₚ known symbols. For exemplary purposes, a Rayleigh multipath fading environment with doppler where fast channel estimation is crucial, is considered. Let the number of received symbols used in estimating the channel be Nₛ. Then, user k has NₚNₛ known symbols that it can use to estimate the L_{f} equalizer taps over a time span of Nₛ symbols. The equalizer taps generated by the Nₚ pilot sequences are then used to equalize and despread the k^{th} user. This may be done via the LMS algorithm operating simultaneously on all Nₚ pilots. The Least Squares (LS) solution may be easily developed as follows:

Let a_{N}^{^{p}}=[(a₀(0) . . . a_{N}^{^{p}}₋₁(0) a₀(1) . . . a_{N}^{^{p}}₋₁(1) a₀(Nₛ-1) . . . a_{N}^{^{p}}₋₁(Nₛ-1)]^{T} be the vector of known transmitted pilot symbols. Then, from equations (6), and (7) the following matrix equation can be written:

CRƒ_{N}^{^{p}}=a_{N}^{^{p}} (11)

where R(i,j)=r(i+d_{f}−j)i=0, . . . N Nₛ, j=0, . . . L_{f}−1 and C is a (Nₛ Nₚ ×N Nₛ) matrix comprising the pilot spreading sequences as follows:

$$C = [ \begin{matrix}{\underline{c}}_{0}^{T} & {\underline{0}}^{T} & ⋯ & {\underline{0}}^{T} \\ ⋮ & ⋮ & ⋮ & \\ {\underline{c}}_{{N}_{p} - 1}^{T} & {\underline{0}}^{T} & ⋯ & {\underline{0}}^{T} \\ {\underline{0}}^{T} & {\underline{c}}_{0}^{T} & … & {\underline{0}}^{T} \\ ⋮ & ⋮ & ⋮ & ⋮ \\ {\underline{0}}^{T} & {\underline{c}}_{{N}_{p} - 1}^{T} & ⋯ & {\underline{0}}^{T} \\ {\underline{0}}^{T} & {\underline{0}}^{T} & ⋯ & {\underline{c}}_{0}^{T} \\ ⋮ & ⋮ & ⋮ & ⋮ \\ {\underline{0}}^{T} & {\underline{0}}^{T} & ⋯ & {\underline{c}}_{{N}_{p} - 1}^{T}\end{matrix} ]$$

Hence, the LS solution for ƒ_{N}^{^{p}} is ƒ_{N}^{^{p}} =(X^{T}X)⁻¹X^{T} a_{N}^{^{p}} where X=CR. Now, this LS estimate is based solely on the pilot symbols. However, user k may use this same equalizer vector to equalize and demodulate its data.

It should be understood that besides using the least squares solution, other techniques may be used to solve for the equalizer taps ƒ_{N}^{^{p}} including Kalman techniques.

FIG. 5 illustrates the tracking performance of the above algorithm in a realistic situation. The system parameters used in this example are the same as described previously with respect to FIG. 2, except L_{f}=20 and d_{f}=8 to account for the increased spread of the channel. The channel is a 5-ray chip-spaced Rayleigh fading channel with a mobile speed of 60 mph. The simulation results are obtained by averaging over 1000 different channel realizations. ƒ_{N}^{^{p}} is estimated by the LS algorithm described herein and then used to demodulate the rest of the users. The first Nₚ sequences are the pilots. As one would expect, the greater the number of pilot sequences in the system, the better the performance of all users. For example, as shown in FIG. 5, the system implementing 12 pilot sequences, performs much better in terms of improved SNR as indicated by graph 80, as opposed to the system using smaller number of pilot sequences 78, 79. However, this comes at a loss of available sequences for data users. Instead of using one pilot sequence with 20% power, it is more advantageous from a tracking perspective to use 20% of the sequences as pilots. This gives added tracking ability for all users in the system, for the same total transmitted pilot power. The loss in number of available sequences for data users is made up by the increased SNR of the supported users, as is evident from FIG. 5. Much higher mobile speeds of 100 mph are also possible with 12 pilot sequences.

It is thus apparent that the chip-equalizer adapted on pilot sequence(s) performs very close to the optimal MMSE equalizer for all users. Moreover, increasing the number of pilot sequences is a better way of tracking fast channel variations rather than increasing the power of a single pilot. While this may be thought of as very similar to an OFDM system which uses multiple pilot tones to track channel variations, here, the multiple spreading sequences serve the same purpose. However, the difference is that in OFDM, each pilot tone characterizes only one frequency and then interpolation between tones must be used to determine the frequency response of the entire spectrum, whereas in a DS-CDMA system with multiple pilot sequences, if each sequence has a frequency response that spans the entire spectrum, no interpolation is necessary and the equalizer taps can be very easily determined either by LMS, Kalman, or least-square methods.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Having thus described my invention, what I claim as new, and desire to secure by Letters Patent is:

1. A method for communicating information symbols in a Direct Sequence- Code Division Multiplex communication system (DS-CDMA) including a base station for transmitting a signal including multiple information symbols destined for multiple mobile users simultaneously over a single channel having a channel response, said method comprising:
a) generating a pilot sequence for synchronizing communication between said base and said mobile users and transmitting said pilot signal with said signal over said single channel for receipt by a receiver device at each said multiple mobile users;
b) providing at each user receiver device, an adaptive chip equalizer capable of tracking said channel response;
c) adapting one or more equalizer taps of said adaptive chip equalizer using said received pilot signal at each said receiver device, said adapting for minimizing received information symbol errors; and
c) despreading said signal using a chipping sequence associated with that mobile user to extract the information symbols for that user from said single channel.

2. The method for communicating information symbols as claimed in claim 1, wherein a power for a transmitted pilot signal is equal to the power of information symbol sequences transmitted for each mobile user.

3. The method for communicating information symbols as claimed in claim 2, wherein as power for a transmitted pilot signal increases, a power transmitted for each mobile user decreases for the same total transmitted power.

4. The method for communicating information symbols as claimed in claim 1, wherein the step a) includes generating a plurality of pilot sequences each having a known chipping sequence and transmitting said plurality of pilot signals simultaneously with said signal over said single channel, said step c) including adapting one or more equalizer taps of said adaptive chip equalizer using each said received pilot signals.

5. The method for communicating information symbols as claimed in claim 4, wherein said adapting step c) is performed at a greater speed using when adapting said adaptive chip equalizer based on said received plurality of pilot signals as compared to when adapting based upon a single pilot signal, whereby said plurality of pilots enable efficient tracking of fast varying channels.

6. The method for communicating information symbols as claimed in claim 1, wherein said pilot signal is transmitted continuously, said method thus enabling continuous equalizer adaptation.

7. A Direct Sequence-Code Division Multiplex (DS-CDMA) communication system comprising:
a base station for transmitting a signal including multiple information symbols destined for multiple mobile users simultaneously over a single channel having a channel response;
mechanism for generating a pilot sequence having known chipping sequence and transmitting said pilot signal with said signal over said single channel for receipt by a receiver device at each said multiple mobile users; an adaptive chip equalizer provided at each user receiver device capable of tracking said channel response;
mechanism for adapting one or more equalizer taps of said adaptive chip equalizer using said received pilot signal at each said receiver device, said adapting for minimizing received symbol errors, wherein said receiver de-spreads said signal using a chipping sequence associated with that mobile user to extract the information symbols for that user from said single channel.

8. The DS-CDMA system as claimed in claim 7, wherein a power for a transmitted pilot signal is equal to the power transmitted for each user.

9. The DS-CDMA system as claimed in claim 8, wherein as power for a transmitted pilot signal increases, a power transmitted for each mobile user decreases for the same total transmitted power.

10. The DS-CDMA system as claimed in claim 7, wherein said base station includes means for generating a plurality of pilot sequences each having a known chipping sequence and transmitting said plurality of pilot signals simultaneously with said signal over said single channel, said mechanism for adapting one or more equalizer taps of said adaptive chip equalizer using each said received pilot signals.

11. The DS-CDMA system as claimed in claim 10, wherein said adapting mechanism executes at a greater speed using when adapting said adaptive chip equalizer based on said received plurality of pilot signals as compared to when adapting based upon a single pilot signal, whereby said plurality of pilots enable efficient tracking of fast varying channels.

12. The DS-CDMA system as claimed in claim 7, wherein said pilot signal is transmitted continuously, said method thus enabling continuous equalizer adaptation.

13. A method for adapting chip equalizers used for receiving symbols in rapidly fading channels, said method comprising:
a) generating a plurality of pilot sequences each having a known chipping sequence;
b) transmitting said plurality of pilot signals simultaneously with a signal including multiple information symbols comprising data sequences destined for multiple mobile users simultaneously over a single channel,
c) providing at each user receiver device, an adaptive chip equalizer capable of tracking a channel response, and obtaining an equalizer output capable of being de-spread to obtain a data sequence for a particular user;
d) adapting one or more equalizer taps of said adaptive chip equalizer using said received pilot signals at said receiver device, said adapting for minimizing received information symbol errors; and
e) de-spreading said signal using a chipping sequence associated with that mobile user to extract the information symbols for that user from said single channel.

14. The method as claimed in claim 13, wherein said adapting step d) includes the implementing a least squares method comprising steps of:
generating a vector a_{N}^{^{p}} of known transmitted pilot information symbols;
generating a matrix C of pilot spreading sequences; and,
estimating said equalizer taps ƒ_{N}^{^{p}} according to:
ƒ_{N}^{^{p}}=(X^{T}X)⁻¹X^{T}a_{N}^{^{p}} where X=CR
and where R(i,j)=r(i+d_{f}−j)i=0, . . . N Nₛ,j=0,. . . L_{f}−1 with Nₛ being the number of received symbols used in estimating the channel response; and L_{f} is the total number of equalizer taps.
